(19) United States
(12) Patent Application Publication
(10) Pub. No.: US 2010/0309859 A1
(43) Pub. Date: Dec. 9, 2010

(54) SESSION CONTROL METHOD FOR USE IN RADIO COMMUNICATION SYSTEM

(75) Inventors: Jae Wook Shin, Daejeon (KR); Ae Soon Park, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignees: KT CORPORATION, Seongnam-city, Kyeongki-do (KR); Electronics and Telecommunications Research Institute, Daejeon (KR)

(21) Appl. No.: 12/745,523

(22) PCT Filed: Nov. 27, 2008
(86) PCT No.: PCT/KR2008/006994

§ 371 Date: May 28, 2010

(30) Foreign Application Priority Data
Nov. 30, 2007 (KR) 10-2007-0123499

(51) Int. Cl. H04W 4/00

(52) U.S. Cl. 370/329

(57) ABSTRACT

A session control method for use in a radio communication system is provided. In the session control method, a session management (SM) protocol message for the setting or the cancellation of a session is transmitted with the aid of a radio resource control (RRC) protocol message of a lower layer for the setting or the cancellation of a radio bearer. Therefore, it is possible to reduce the number of signalling messages to a radio interface and thus to minimize signalling delays. In addition, it is possible to realize a many-to-one correspondence between services and bearers and realize efficient packet services in an evolved radio communication system by separately defining service identifiers and bearer identifiers and selectively setting or cancelling a bearer according to the correspondence between services and bearers.

### TECHNICAL FIELD

The present invention relates to a session control method for use in a radio communication system, and more particularly, to session control method for use in a radio communication system, which can efficiently control packet services in a radio communication system.

This work was supported by the IT R & D program of MIC/IITA [2005-S-404-33, “Research & development on Mobile Terminal Technology based on 3G Evolution’].

### BACKGROUND ART

In general, service control in a radio communication system is performed through a session management protocol in a radio interface between a network and a terminal.

When it is necessary to perform a new service or terminate a current service currently being performed, a terminal triggers the setting of a new session between the terminal and a packet network or the cancellation of an existing session between the terminal and the packet network, thereby generating context information regarding the new service or deleting context information regarding the current service.

That is, when a new service is initiated, a terminal generates session setting information necessary for performing the new service and transmits the session setting information to a network. Then, the network may either allow the new service to be performed or transmit modified quality of service (QOS) information to the terminal, if negotiations are required, according to the session setting information. If the performing of the new service is allowed by the network, the network may trigger a bearer setting procedure for the terminal so that a bearer necessary for performing the new service can be set for the terminal.

The above-mentioned session control method, however, requires a terminal to transmit QOS information and packet filter information of a service to a network and requires the network to undergo authorization or negotiation processes for a service requested by a terminal, thereby causing delays in the setting of a session. In addition, the above-mentioned session control method requires QOS information and packet filter information to be configured for each and every service, thereby making it difficult to realize a terminal and causing incompatibility between a terminal and a network.

Conventionally, session control for the management of service context information is performed in a session management protocol, and bearer control for the transmission of service data is performed in a radio resource control (RRC) protocol. Therefore, in order to activate a service, the setting of a session and the setting of a bearer may need to be sequentially performed in a radio interface, thereby causing signaling delays.

### DISCLOSURE OF INVENTION

### Technical Problem

The present invention provides a session control method for use in a radio communication system, in which a many-to-one correspondence between services and bearers can be realized and delays in signaling can be minimized by performing the setting and the cancellation of a radio bearer, including the setting and the cancellation of a session, at the same time.

### Technical Solution

According to an aspect of the present invention, there is provided a session control method for use in a radio communication system, the session control method including receiving a request for a predetermined service from a user terminal and issuing a request for the activation of context by using a radio resource control (RRC) protocol message for setting a session for a user terminal in response to the received request; receiving a response message for the RRC protocol message from the user terminal, the received response message comprising a context activation completion message indicating that the setting of context is complete; and setting a session for the user terminal and providing the predetermined service to the user terminal.

The session control method may also include generating a context activation request message for the predetermined service, wherein the context activation request message may include at least one of a service identifier (ID), quality-of-service (QOS) information, uplink packet filter information and a bearer ID of the predetermined service.

The context activation request message may be a session management protocol message.

A layer corresponding to the session control protocol message may be higher than a layer corresponding to the RRC protocol message.

The session control method may also include setting context corresponding to the predetermined service based on the RRC protocol message.

The session control method may also include determining whether there is a radio bearer already set for the predetermined service.

If there is no radio bearer set for the predetermined service, the RRC protocol message may be a radio bearer setting message.

The radio bearer setting message may include at least one of a radio bearer ID of a new radio bearer to be set, setting information regarding the new radio bearer, and a bearer ID of a bearer including the new radio bearer.

The session control method may also include setting a new bearer for the user terminal based on the radio bearer setting message.

The response message for the RRC protocol message may be a radio bearer setting completion message.

If there is a radio bearer already set for the predetermined service, the RRC protocol message may be a downlink direct transfer (DDT) message.

The response message for the RRC protocol message may be an uplink direct transfer (UDT) message.

According to another aspect of the present invention, there is provided a session control method for use in a radio communication system, the session control method including receiving a request for the termination of a predetermined service from a user terminal and issuing a request for the inactivation of context corresponding to the predetermined service with the use of an RRC protocol message; receiving a response message for the RRC protocol message from the user terminal, the response message comprising a context inactivation completion message indicating that the inactivation of the context corresponding to the predetermined service is complete; and cancelling a session set for the user terminal and terminating the predetermined service.

The session control method may also include generating a context inactivation request message for the predetermined message, wherein the context inactivation request message comprises at least one of a radio bearer ID of a radio bearer providing the predetermined service, information indicating the number of services corresponding to the radio bearer, and a service ID of the predetermined service.

The session control method may also include deleting the context corresponding to the predetermined service from the user terminal.

The session control method may also include determining the number of services corresponding to a radio bearer set for the user terminal.

If only one service corresponds to the radio bearer set for the user terminal, the RRC protocol message may be a radio bearer cancellation message.

The session control method of claim 17, further comprising cancelling the radio bearer set for the user terminal based on the radio bearer cancellation message.

The response message for the RRC protocol message may be a radio bearer cancellation completion message.

If two or more services correspond to the radio bearer set for the user terminal, the RRC protocol message may be a DDT message.

The response message for the RRC protocol message may be a UDT message.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a block diagram of a session control apparatus of a radio communication system according to an embodiment of the present invention;

FIG. 2 illustrates a diagram of a radio interface protocol architecture according to an embodiment of the present invention;

FIG. 3 illustrates a diagram for explaining the correspondence between services and bearers in the radio communication system illustrated in FIG. 1;

FIG. 4 illustrates a flowchart of a method of setting a session according to an embodiment of the present invention;

FIG. 5 illustrates a flowchart of a method of setting a session according to another embodiment of the present invention;

FIG. 6 illustrates a flowchart of a method of cancelling a session according to an embodiment of the present invention; and

FIG. 7 illustrates a flowchart of a method of cancelling a session according to another embodiment of the present invention.

### BEST MODE FOR CARRYING OUT THE INVENTION

The present invention will now be described more fully with reference to the accompanying drawings, in which exemplary embodiments of the invention are shown.

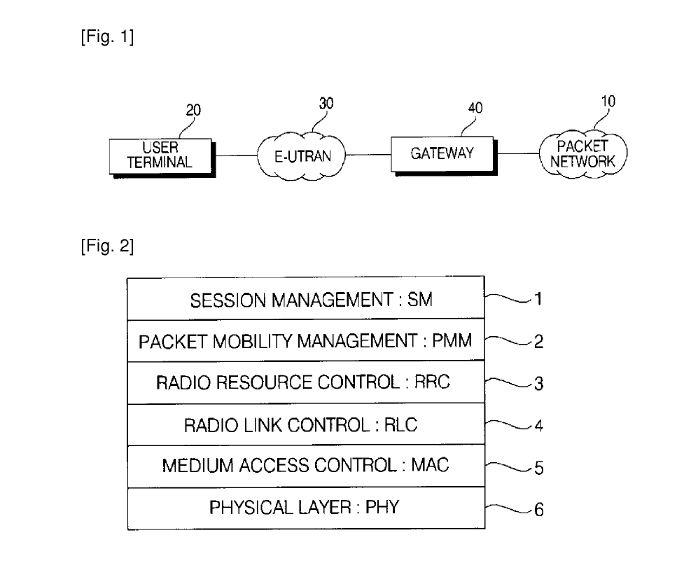

FIG. 1 illustrates a block diagram of a session control apparatus of a radio communication system according to an embodiment of the present invention. Referring to FIG. 1, the radio communication system is an evolved packet system (EPS), which has evolved from a 3^{rd} Generation Partnership Project (3GPP) system. An EPS prefers a network-controlled service model over an existing terminal control-based service model and defines a bearer model, which can realize a many-to-one correspondence between services having similar quality-of-service (QOS) properties and bearers in order to effectively control bearers and the QOS of services.

An EPS is a packet-optimization mobile communication system aiming at transmitting data at higher speed than existing mobile communication systems and causing fewer transmission delays. Thus, an EPS can provide multimedia services to users at high speed.

Referring to FIG. 1, the session control apparatus may include a network N, which provides services upon request, and a user terminal 20, which is provided with at least one service by accessing the network N.

The user terminal 20 may be a portable terminal capable of supporting mobility such as a mobile communication terminal or a personal digital assistant (PDA).

The network N may include a packet network 10, an evolved universal terrestrial radio access network (E-UTRAN) 30, and a gateway 40. The network N may also include a mobility management entity (MME) (not shown), a home subscriber server (HSS) (not shown), and a policy-and-charging rule function (PCRF) (not shown).

The packet network 10 provides packet services to the user terminal 20. The gateway 40 is an intermediary between the packet network 10 and the user terminal 20 and transmits signals transmitted between the packet network 10 and the user terminal 20. The gateway 40 may include a serving gateway (S-GW), which processes signals transmitted by the user terminal 20 and transmits the processed signals, and a packet data network gateway (P-GW), which processes signals transmitted by the packet network 10 and transmits the processed signals.

The user terminal 20 controls services and radio bearers by transmitting signals to or receiving signals from the E-UTRAN 30 and the MME. A traffic bearer for transmitting data packets may be set between the user terminal 20 and the P-GW and may thus support packet services between the user terminal 20 and the packet network 10.

FIG. 2 illustrates a diagram of a radio interface protocol architecture according to an embodiment of the present invention. Referring to FIG. 2, a Session Management (SM) protocol 1 is an uppermost layer of the radio interface protocol architecture, a packet mobility management (PMM) protocol 2 is disposed directly below the SM protocol 1, a radio resource control (RRC) protocol 3 is disposed directly below the PMM protocol 2, a radio link control (RLC) protocol 4 is disposed directly below the RRC protocol 3, a medium access control (MAC) protocol 5 is disposed directly below the RLC protocol 4, and a physical (PHY) layer 6 is disposed directly below the MAC protocol 5.

The RRC protocol 3, which is a protocol for performing radio access and radio bearer control functions, controls the setting of the underlying layers (i.e., the RLC protocol 4, the MAC protocol 5 and the PHY layer 6) and sets or cancels radio bearers for performing signalling and traffic transmission.

An RRC protocol message may include an SM protocol message and a PMM protocol message of upper layers and may be transmitted through signalling radio bearers set by lower layers. An SM protocol message and a PMM protocol message may be transmitted by being included in an uplink direct transfer (UDT) message or a downlink direct transfer (DDT) message of the RRC protocol.

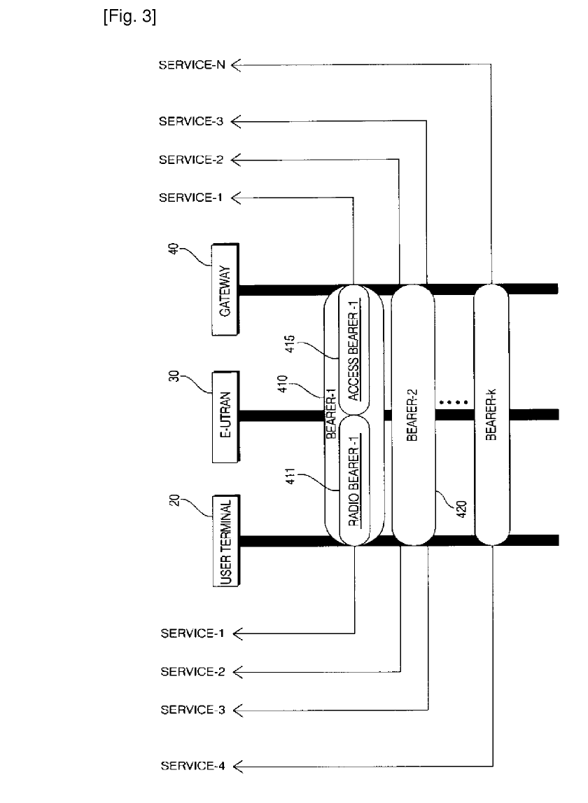

FIG. 3 illustrates a diagram for explaining the correspondence between services and bearers in the radio communication system illustrated in FIG. 1. Referring to FIG. 3, an EPS may include a plurality of bearers. Each of the bearers includes a radio bearer, which is formed between the user terminal 20 and the E-UTRAN 30, and an access bearer, which one-to-one corresponds to the radio bearer and is formed between the E-UTRAN 30 and the gateway 40.

Each of the bearers may correspond to at least one packet service. More specifically, the bearers may be in a one-to-one or many-to-one correspondence with a plurality of packet services. That is, a bearer may correspond to only one packet service or may correspond to two or more packet services. The correspondence between the bearers and a plurality of packet services may be determined according to the QOS properties of the packet services and a QOS control policy set by a network administrator.

For example, a plurality of services having a non-guaranteed bitrate (Non-GBR) property may all correspond to one bearer, whereas a plurality of services having a guaranteed bit rate (GBR) property may one-to-one correspond to a plurality of GBR bearers that can satisfy the QOS of the services having the GBR property.

A session control method for use in the radio communication system illustrated in FIG. 3 will hereinafter be described in further detail.

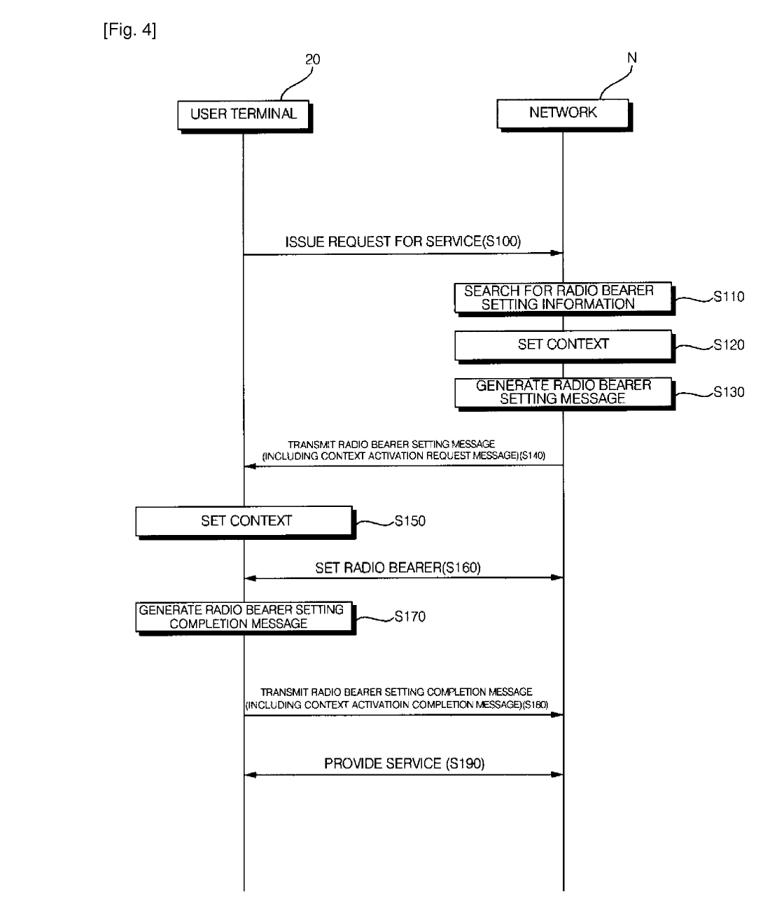

FIG. 4 illustrates a flowchart of a method of setting a session according to an embodiment of the present invention, and particularly, the setting of a radio bearer between the user terminal 20 and the network N and the providing of a packet service through the radio bearer. Referring to FIG. 4, the user terminal 20 issues a request for a predetermined service to the network N through the gateway 40 (S100). The network N searches for radio bearer setting information for providing the predetermined service in response to the request issued by the user terminal 20 (S110), and generates a radio bearer setting message (S130). The radio bearer setting message is an RRC protocol message and includes at least one of a bearer identifier (ID) (Bearer_ID), a radio bearer ID (RB_ID), and the radio bearer setting information.

Thereafter, the network N sets context for setting a packet data protocol (PDP) for the predetermined service (S120). In order to set a session for the predetermined service, the network N may transmit a context activation request message to the user terminal 20 (S140). The context activation request message is an SM protocol message and may be transmitted by being included in a radio bearer setting message of a lower layer.

The context activation request message may include at least one of a service ID (NSAPI), QOS information, uplink packet filter information (UL_PF), and a bearer ID (Bearer_ID).

When a radio bearer setting message including the context activation request message is received from the network N, the user terminal 20 generates context based on the context activation request message according to PDP settings (S150). Thereafter, the user terminal 20 sets a radio bearer between the user terminal 20 and the network N based on the received radio bearer setting message (S160).

Thereafter, the user terminal 20 generates a radio bearer setting completion message indicating that a radio bearer has been set between the user terminal 20 and the network N (S170), and transmits the message to the network N (S180). The context activation completion message may be transmitted to the network N by being included in the radio bearer setting completion message, which is a response message for the radio bearer setting message.

Thereafter, the network N receives the radio bearer setting completion message transmitted by the user terminal 20, and completes the setting of a session between the user terminal 20 and the network N. Thereafter, the network N provides the user terminal 20 with the service requested by the user terminal 20 by using the session set between the user terminal 20 and the network N (S190).

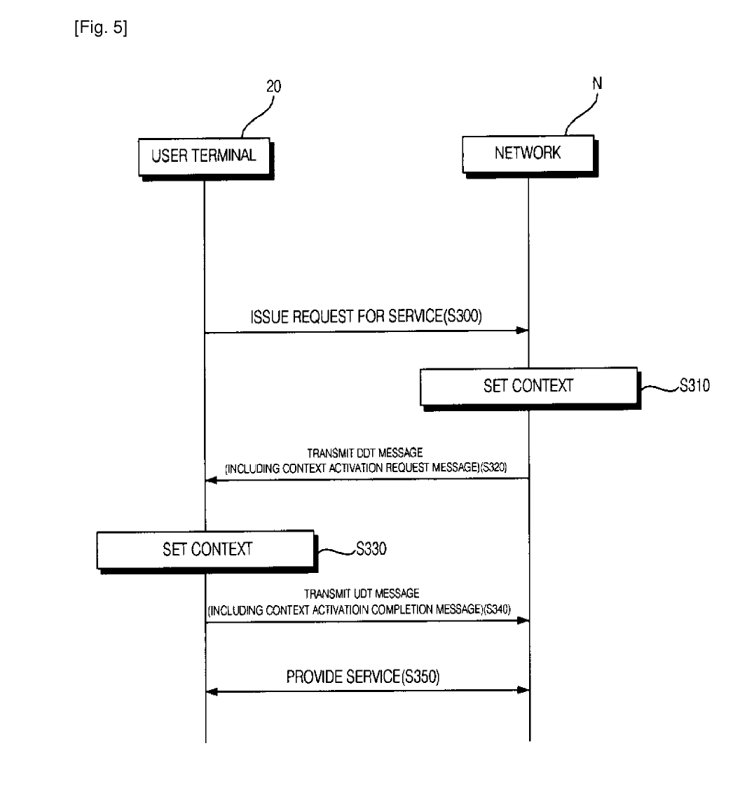

FIG. 5 illustrates a flowchart of a method of setting a session according to another embodiment of the present invention, and particularly, the providing of a packet service through a radio bearer. Referring to FIG. 5, the user terminal 20 issues a request for a predetermined service to the network N (S300). Then, the network N sets context for setting a session for the predetermined service (S310). Thereafter, the network N generates a context activation request message and transmits the context activation request message to the user terminal 20 (S320). In the embodiment of FIG. 5, unlike in the embodiment of FIG. 4, the context activation request message may be transmitted to the network N by being included in a DDT message, instead of being carried on a radio bearer setting message. The context activation request message is a SM protocol message, and may include at least one of a service ID (NSAPI) of the predetermined service, QOS information, uplink packet filter information (UL_PF), and a bearer ID (Bearer_ID) corresponding to the predetermined service. The DDT message used to transmit the context activation request message is an RRC protocol message corresponding to a lower layer than that of the context activation request message.

The user terminal 20 receives the DDT message transmitted by the network N, and generates context for the predetermined service based on the context activation request message included in the received DDT message (S330). Thereafter, the user terminal 20 generates a context activation completion message and transmits the context activation completion message to the network N by being included in a UDT message (S340).

The network N receives the context activation message transmitted by the user terminal 20 and completes the setting of a session between the user terminal 20 and the network N. Thereafter, the network N provides the user terminal 20 with the predetermined service through the session between the user terminal 20 and the network N (S350).

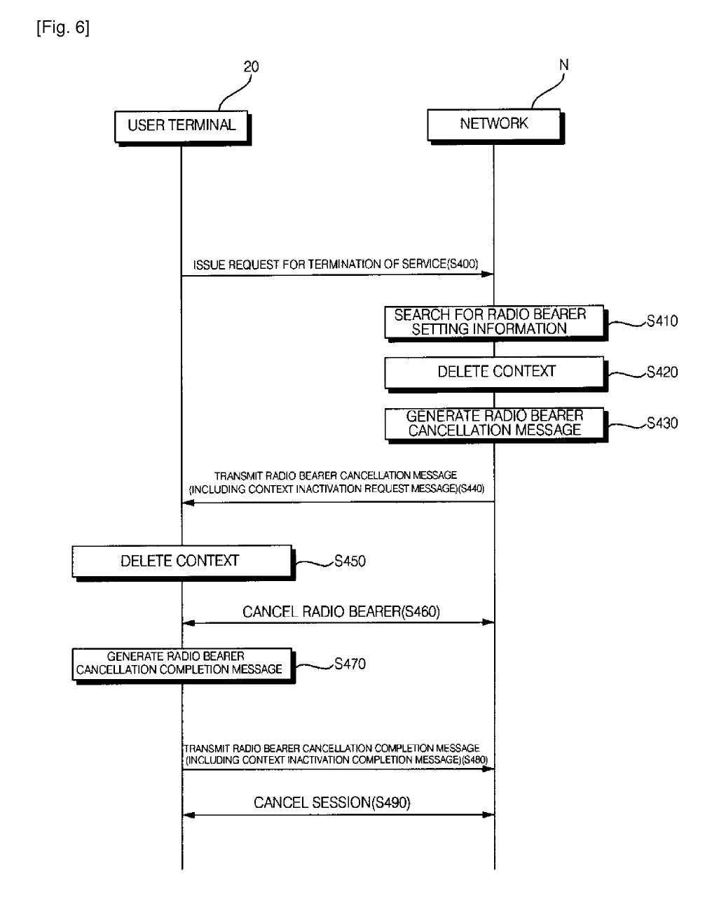

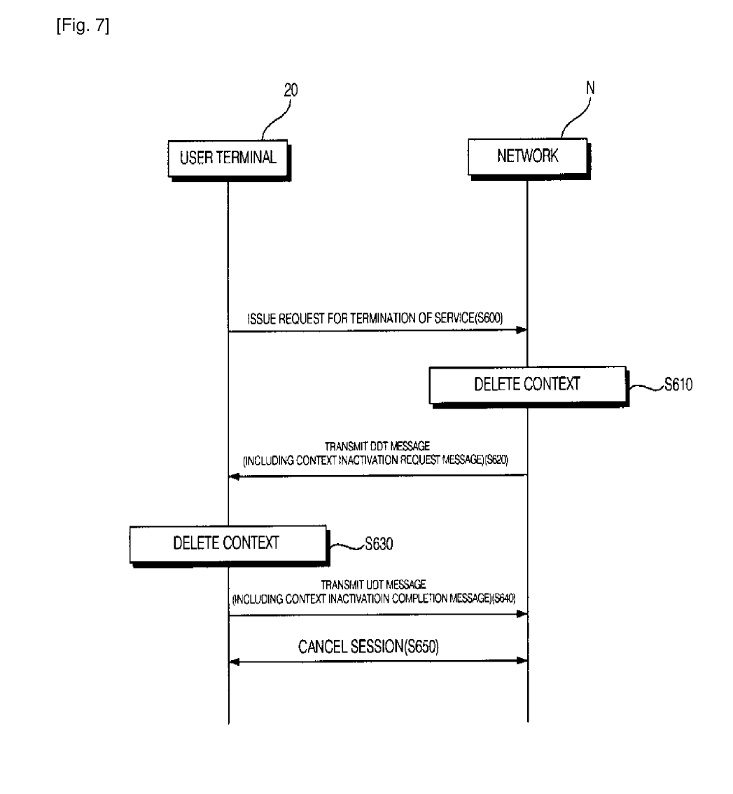

FIG. 6 illustrates a flowchart of a method of cancelling a session according to an embodiment of the present invention, and FIG. 7 illustrates a flowchart of a method of cancelling a session according to another embodiment of the present invention. More specifically, the embodiments of FIGS. 6 and 7 are different from each other in terms of how many services correspond to one bearer. In the embodiment of FIG. 6, one service corresponds to one bearer.

Referring to FIG. 6, the user terminal 20 issues a request for the termination of a predetermined service to the network N (S400). The network N searches for radio bearer setting information corresponding to the predetermined service in response to the request issued in operation 5400 (S410) and generates a radio bearer cancellation message (S430).

The radio bearer cancellation message is an RRC protocol message and may include at least one of a bearer ID (Bearer_ID) of a bearer including a radio bearer to be cancelled and a radio bearer ID (RB_ID) of the radio bearer to be cancelled. The network N transmits the radio bearer cancellation message to the user terminal 20 (S440).

The network N deletes context corresponding to the predetermined service in order to cancel a session for the predetermined service (S420), and transmits a context inactivation request message to the user terminal 20 (S440). The context inactivation request message may be inserted into the radio bearer cancellation message, and then the radio bearer cancellation message may be transmitted to the user terminal 20 (S440).

The context inactivation request message is an SM protocol message and may include at least one of a bearer identifier Bearer_ID, and a service identifier NSAPI of the predetermined service.

When the radio bearer cancellation message including the context inactivation request message is received, the user terminal 20 deletes context corresponding to the predetermined service based on the context inactivation request message (S450). Thereafter, the user terminal 20 cancels a radio bearer set between the user terminal 20 and the network N based on the radio bearer cancellation message (S460).

Thereafter, the user terminal 20 generates a message indicating that the cancellation of a radio bearer is complete (S470), and transmits the message to the network N (S480). In addition, the user terminal 20 generates a context inactivation completion message indicating that the inactivation of the context corresponding to the predetermined service is complete, and transmits the inactivation completion message to the network N. The context inactivation completion message may be inserted into a radio bearer cancellation completion message, and then, the radio bearer cancellation completion message may be transmitted to the network N.

When the radio bearer cancellation completion message including the context inactivation completion message is received, the network N cancels a session set between the user terminal 20 and the network N (S490).

In the embodiment of FIG. 7, two or more services correspond to one bearer. Referring to FIG. 7, the user terminal 20 issues a request for the termination of a predetermined service to the network N (S600). The network N deletes context corresponding to the predetermined service (S610), and transmits a context inactivation request message to the user terminal 20 in order to cancel a session for the predetermined service (S620).

In the embodiment of FIG. 7, unlike in the embodiment of FIG. 6, the context inactivation request message may be transmitted by being included in a DDT message. The context inactivation request message may include at least one of a bearer ID (Bearer_ID) of a bearer corresponding to the predetermined service, and a service identifier of the predetermined service.

When the DDT message including the context inactivation request message is received, the user terminal 20 deletes context corresponding to the predetermined service with reference to the context inactivation request message (S630). Thereafter, the user terminal 20 generates a context inactivation completion message indicating that the inactivation of the context corresponding to the predetermined service is complete, and transmits the context inactivation completion message to the network N (S640). The context inactivation completion message may be transmitted by being included in a UDT message.

When the UDT message including the context inactivation completion message is received, the network N cancels a session set between the user terminal 20 and the network N (S650).

### INDUSTRIAL APPLICABILITY

According to the present invention, it is possible to reduce the number of signalling messages to a radio interface and thus to minimize signalling delays by inserting a message for the setting or the cancellation of a session in a message of a lower layer for the setting or the cancellation of a bearer.

In addition, according to the present invention, it is possible to further reduce the number of signalling messages to a radio interface and thus to further minimize signalling delays by transmitting an SM protocol message for the setting or the cancellation of a session with the aid of an RRC protocol message of a lower layer for the setting or the cancellation of a radio bearer.

Moreover, according to the present invention, it is possible to realize a many-to-one correspondence between services and bearers and realize efficient packet services in an evolved radio communication system by separately defining service identifiers and bearer identifiers and selectively setting or cancelling a bearer according to the correspondence between services and bearers.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A session control method for use in a radio communication system, comprising:
receiving a request for a predetermined service from a user terminal and issuing a request for the activation of context by using a radio resource control (RRC) protocol message for setting a session for a user terminal in response to the received request;
receiving a response message for the RRC protocol message from the user terminal, the received response message comprising a context activation completion message indicating that the setting of context is complete; and
setting a session for the user terminal and providing the predetermined service to the user terminal.

2. The session control method of claim 1, further comprising generating a context activation request message for the predetermined service,
wherein the context activation request message comprises at least one of a service identifier (ID), quality-of-service (QOS) information, uplink packet filter information and a bearer ID of the predetermined service.

3. The session control method of claim 2, wherein the context activation request message is a session management (SM) protocol message.

4. The session control method of claim 3, wherein a layer corresponding to the SM protocol message is higher than a layer corresponding to the RRC protocol message.

5. The session control method of claim 1, further comprising setting context corresponding to the predetermined service based on the RRC protocol message.

6. The session control method of claim 1, further comprising determining whether there is a radio bearer already set for the predetermined service.

7. The session control method of claim 6, wherein, if there is no radio bearer already set for the predetermined service, the RRC protocol message is a radio bearer setting message.

8. The session control method of claim 7, wherein the radio bearer setting message comprises at least one of a radio bearer ID of a new radio bearer to be set, setting information regarding the new radio bearer, and a bearer ID of a bearer including the new radio bearer.

9. The session control method of claim 7, further comprising setting a new bearer for the user terminal based on the radio bearer setting message.

10. The session control method of claim 9, wherein the response message for the RRC protocol message is a radio bearer setting completion message.

11. The session control method of claim 6, wherein, if there is a radio bearer already set for the predetermined service, the RRC protocol message is a downlink direct transfer (DDT) message.

12. The session control method of claim 11, wherein the response message for the RRC protocol message is an uplink direct transfer (UDT) message.

13. A session control method for use in a radio communication system, the SC method comprising:
receiving a request for the termination of a predetermined service from a user terminal and issuing a request for the inactivation of context corresponding to the predetermined service with the use of an RRC protocol message;
receiving a response message for the RRC protocol message from the user terminal, the response message comprising a context inactivation completion message indicating that the inactivation of the context corresponding to the predetermined service is complete; and
cancelling a session set for the user.

14. The session control method of claim 13, further comprising generating a context inactivation request message for the predetermined message,
wherein the context inactivation request message comprises at least one of a radio bearer ID of a radio bearer providing the predetermined service, and a service ID of the predetermined service.

15. The session control method of claim 13, further comprising inactivating the context corresponding to the predetermined service from the user terminal.

16. The session control method of claim 13, further comprising determining the number of services corresponding to a radio bearer set for the user terminal.

17. The session control method of claim 16, wherein, if only one service corresponds to the radio bearer set for the user terminal, the RRC protocol message is a radio bearer cancellation message.

18. The session control method of claim 17, further comprising cancelling the radio bearer set for the user terminal based on the radio bearer cancellation message.

19. The session control method of claim 18, wherein the response message for the RRC protocol message is a radio bearer cancellation completion message.

20. The session control method of claim 16, wherein, if two or more services correspond to the radio bearer set for the user terminal, the RRC protocol message is a DDT message.
